(19) United States
(12) Patent Application Publication
(10) Pub. No.: US 2017/0036848 A1
(43) Pub. Date: Feb. 9, 2017

(54) PLASTIC AEROSOL CONTAINER, PREFORM AND METHOD

(71) Applicant: Petainer Large Container IP Limited, London (GB)

(72) Inventors: Stanislav CHURY, Cheb (CZ); Vilem KUHN, As (CZ)

(73) Assignee: Petainer Large Container IP Limited, London (GB)

(21) Appl. No.: 15/120,078

(22) PCT Filed: Feb. 18, 2015
(86) PCT No.: PCT/GB2015/050463

§ 371 Date: Aug. 18, 2016

(30) Foreign Application Priority Data
Feb. 18, 2014 (GB) 1402885.6

(51) Int. Cl. B65D 83/38; B29C 49/08; B29C 49/06; B29B 11/08; B29C 65/08

(52) U.S. Cl. CPC B65D 83/38; B29B 11/08; B29C 65/08; B29C 49/06; B29C 49/08; B29C 2049/021

(57) ABSTRACT

A plastic aerosol container (10), an associated preform (10a) and a method of manufacturing the preform (10a) and container (10) is described. The container (10) comprises an adapter (20) that defines an opening (11) of the container (10), the opening (11) being arranged to receive and be sealed by an aerosol valve cap (3). The container (10) also comprises a body 40 that defines an internal volume of the aerosol container (10). The container (10) is blow-moulded from a preform (10a) ideally having a corresponding adapter (20a) and body (40a) which are secured to one another, with an expansion region (45a, 46a) of the body (40a) of the preform (10a) being arranged to be expanded to form the internal volume of the aerosol container (10).

This invention relates to an aerosol container formed of a plastics material, ideally PET. Furthermore, the invention also relates to a preform for producing an aerosol container, and a method of manufacturing the preform and/or the aerosol container.

Conventional aerosol assemblies are primarily constructed of metals such as aluminium or steel. In such assemblies, a broadly cylindrical metal container is filled with a product and an aerosol valve assembly is sealed to an opening of the container. A propellant is then inserted via the valve to pressurise the product. Alternatively, the combined product and propellant may be inserted into the container via the valve of the valve assembly after the container is sealed.

The aerosol valve assembly has a valve cap which is crimped around the opening to form the seal, and also a dip tube through which a pressurised product can be driven out from the bottom of the container in use. Typically, the aerosol valve assembly is provided as a standard unit which is fitted to containers of different sizes.

Conventional metal aerosol assemblies have a number of drawbacks. Metals such as aluminium and steel can be relatively expensive. Furthermore, they are opaque, making it difficult for a user to determine the quantity of product remaining in the assembly, and also how to tilt the assembly to ensure that the end of the dip tube can extract the dregs of a liquefied product. Metals can be readily dented and prone to damage, and causing damage if dropped. Certain metals such as steel are prone to corrosion or other chemical attack, necessitating protective coatings which further increase the expense of manufacturing such aerosol assemblies.

In view of these drawbacks, efforts have been made to product aerosol containers predominantly constructed of low-cost plastics materials such as polyethylene terephthalate (PET).

For example, U.S. Pat. No. 6,390,326 by Hung describes an aerosol container having a body that is blow-moulded from PET. A metal collar is then fitted around the neck of the body, and a standard valve cap is crimped around the collar and neck in the conventional matter. A problem with this approach is that it requires careful placement and retention of the metal collar to the neck of the body prior to crimping. If the metal collar becomes misaligned, for example during transport to a crimping station, then the valve cap may not properly seal to the rest of the container.

One solution to this problem, proposed in European Patent No. 1791769 by Salameh, is to snap-fit a collar to the neck of the body. However, this solution has its own drawbacks. Firstly, the snap-fit binding between the collar and the body can be easily and suddenly reversed. This can easily lead to a pressurised container inadvertently leaking or even exploding. Furthermore, the precise shape of the collar and body is critical to the reliability of the snap-fit bond. This can increase the expense of the manufacturing process and necessitates that the collar and body do not change shape after they are snap-fitted to one another. This prevents the body from being blow-moulded after connection to the collar. Furthermore, the snap-fit connection necessitates a sealing member, for example, a rubber O-ring, to be introduced between the body and the collar. This additional component increases expense, and must be chosen carefully as materials of certain sealing member can perish if exposed to a product or propellant contained within aerosol container.

It is against this background that the present invention has been devised.

### SUMMARY OF THE INVENTION

According to a first aspect of the present invention there is provided a preform arranged to be blow-moulded into an aerosol container. Ideally, the preform comprises an adapter and a body. Ideally, the adapter and body have complementary interfaces via which the adapter and body are secured to one another. Ideally, the adapter defines an opening of the preform. Ideally, the opening is arranged to receive and be sealed by an aerosol valve cap of an aerosol valve assembly. Ideally, the body comprises an expansion region arranged to be expanded via blow-moulding, ideally stretch blow-moulding. Ideally, the expansion region is arranged to be expanded to form an internal volume of the aerosol container. Ideally, said internal volume is the majority of the total internal capacity of the aerosol container. Ideally, said internal volume is at least 70% of the total internal capacity of the aerosol container. Ideally, said internal volume is at least 90% of the total internal capacity of the aerosol container.

Advantageously, as the adapter is part of the preform, it is possible to fit the aerosol valve cap to it directly after blow-moulding the aerosol container. This is in contrast to the approaches proposed by Hung and Salameh in which it is necessary to first blow-mould the container before fitting a collar and then a valve cap.

Furthermore, securing the adapter and body together prior to blow-moulding means that the connection between them can be made more reliable; the unexpanded body is denser, sturdier and so more capable of being manipulated in a way to form a stronger bond between the adapter and the body especially if the formation of that bond relies on force or pressure. Again, this is in contrast with the approaches proposed by Hung and Salameh in which the body is already blow-moulded and so is less robust to manipulation. Accordingly, the sealing of the container can be less reliable.

Another benefit is that a more efficient manufacturing and distribution process can be realised. Preforms can be manufactured at one location, and then transported in large quantities to different second locations where they can be kept as inventory until needed for blow-moulding. As preforms are relatively low-volume compared to the aerosol containers, transport to and storage at the second locations is more space-efficient. Blow-moulding at the second locations can be carried out on-demand, and each of the second locations may be able to produce different containers from one another using a common preform. Unlike the approaches proposed by Hung and Salameh, after blow-moulding, it is possible to proceed directly to fitting the aerosol valve cap to the container. In other words, an adapter need not first be fitted at each of the second locations. This can be achieved centrally at the first location where the preforms are produced in the first place.

It should also be noted that conventional preforms are typically formed from an integral piece of material. However, the present preform is ideally constructed from a first part—the adapter, and a second part—the body. Ideally, to reduce manufacturing expense and complexity, the adapter and/or the body are each formed from an integral piece of plastics material. Furthermore, the adapter and/or the body are ideally each injection-moulded.

Ideally, said material is transparent or translucent. Advantageously, this allows the quantity of product remaining in the aerosol container to be determined by a user. Furthermore, it enables the user to orient the container so that the dregs of a product can be extracted via the dip tube. Ideally, said material is a polymer material, for example a polyester such as polyethylene terephthalate (PET).

The adapter and the body are secured to one another to create the preform. This allows desirable characteristics of the preform, and the associated aerosol container, to be realised over and above conventional preforms.

Preferably, the opening is spaced from the interface of the adapter and/or the expansion region of the body. Advantageously, this means that the opening is resistant to deformation when the preform is blow-moulded to form the aerosol container. This increases the reliability with which an aerosol valve cap can be fitted and held in place on the opening.

It is preferred that the expansion region of the body is spaced from the interface of the body. This minimises the deformation of the region of the preform at which the adapter is secured to the body, and so the strength of the bond between the adapter and the body.

In any case, as the body and the adapter are different parts, and the adapter defines the opening to which the aerosol valve cap is fitted, the opening is protected from the deformation to which the body is subject to during blow-moulding. This is not the case with preforms constructed of an integral material.

The multi-part construction of the preform is also advantageous as it allows the preform to take on a relatively complex shape that would otherwise be difficult or expensive to manufacture from an integral piece of material, especially when using conventional injection moulding techniques. For example, conventional preforms have an internal bore with a draft that widens in the direction of the opening, allowing the preform to be easily withdrawn from an injection mould. Conversely, the present preform ideally comprises an internal bore that narrows towards the opening. This allows the circumferential size of the opening to be smaller than a major circumference of the aerosol container created from the preform. This is useful as a relatively smaller opening equates to a smaller force exerted by internal pressure on a valve cap covering the opening, and so increases the integrity of the container. Moreover, the narrowing of the internal bore of the preform obviates the need to deform a region of the preform adjacent to the opening when blow-moulding a container from the preform. Advantageously, this further minimises deformation of the opening as the shape of the opening will not be significantly changed by blow-moulding. Thus, the valve cap can be more reliably fitted.

Ideally, the part of the preform defined by the adapter is not subject to expansion via blow-moulding at all thereby maintaining the strength and shape of the opening. In conjunction with the multi-part construction, the adapter can thereby comprise a lip around which an aerosol valve cap can be fitted. Moreover, the lip can project radially-inwards so that the aerosol valve cap can be crimp-fitted around the lip. Specifically, the lip can thereby define an undercut which can therefore restrain a crimp-fitted valve cap from sliding out from the opening—i.e. the act of crimping the valve cap enlarges a portion of it so that it cannot fit through the opening. This is important to resist an internal pressure.

Preferably, the adapter and body are sealed to one another. This enables the preform to be blow-moulded. To this end, the complementary interfaces of the body and the adapter may comprise joining surfaces that are joined together and sealed to one another.

The preform is ideally substantially rotationally symmetrical about its longitudinal axis. Preferably, the adapter and the body are substantially rotationally symmetrical about their respective longitudinal axes. Ideally, the adapter and the body share a common longitudinal axis with one another and/or the preform that they together define. The complementary interfaces of the adapter and body ideally encircle the longitudinal axis. In view of this, said joining surfaces are ideally sealed together along a continuous loop. This continuous loop also ideally encircles the longitudinal axis. Ideally, the complementary interfaces comprise complementary mating structures that mate the adapter and body together. This may be via locating one of the mating structures within another. For example, the mating structures may define an annular projection, and an annular groove each sized so that the annular projection can locate within the annular groove.

Ideally, the complementary interfaces are secured together via welding. Advantageously, this can guarantee a strong seal between the adapter and the body thereby increasing the reliability with which the resulting preform can be blow-moulded. Ideally, the complementary interfaces are secured together via ultrasonic welding. This is a particularly effective way of welding together parts each constructed of plastics material.

Ideally, the adapter and/or the body comprise a flange which extends in an outward direction away from an exterior surface of the respective adapter and/or body. Ideally, the or each flange supports the interface of the respective adapter and/or body. Ideally, the interfaces are supported on respective facing surfaces of the flanges. Furthermore, it is preferred that the respective reverse surfaces of the flanges (i.e. reverse to the facing surfaces) are arranged to transmit a clamping force to the facing surfaces so as to press the facing surfaces together.

This feature is particularly synergistic with the features of securing the adapter and body together prior to blow-moulding, especially via welding. This is because the flanges can be used to press the adapter and the body together during welding. Furthermore, as the unexpanded body is denser and sturdier than an expanded body would be, it is more capable of being manipulated and transmitting a binding force. Thus a stronger bond between the adapter and the body can be established. Also, it is clear that this arrangement presents advantages over other joining means (such as screw-threads and O-rings) which are weaker, more costly and/or cannot be employed prior to blow-moulding.

For the avoidance of doubt, the invention also extends to an adapter and/or body for creating the preform of the first aspect of the present invention. As will be appreciated, certain features and advantages of the adapter and/or body are also inherent in the preform, or in the creation of the preform.

For example, the adapter and/or body may comprise at its respective interface at least one energy director shaped to melt upon application of welding energy to facilitate welding of one of the adapter and body to the other. As mentioned, the adapter and/or body may be made from an integral piece of plastics material. Ideally, said at least one energy director is formed from said material and shaped to be more predisposed towards melting upon application of welding energy than an underlying portion of said material. For example, the shape of the energy director may incorporate a sharp edge or tip at which welding energy can be focused to preferentially melt the energy director. This can improve the accuracy with which a weld zone can be created.

Ideally, the at least one energy director is positioned and arranged so that, when melted upon application of welding energy, it forms a continuous molten loop for joining and sealing together the complementary interfaces of the adapter and/or body. Said molten loop ideally encircles the longitudinal axis.

As mentioned, the complementary interfaces may comprise complementary mating structures that mate the adapter and body together, for example, by locating one of the mating structures (such as an annular projection) within another (such as an annular groove). Mating can therefore be achieved by aligning the respective longitudinal axes of the adapter and the body, and then pushing them together. When the mating structures locate within one another relative movement between the adapter and the body can therefore be confined. Specifically, relative translational movement is confined along the longitudinal axis.

As a result of this, the mating features can complement the manner in which the adapter and body are secured to one another, especially when welding is used as a securing means. This is because the mating structures can ensure that the surfaces of the adapter and body that are to be welded together are properly aligned with one another. Furthermore, molten material generated during welding can fill any gaps between the mating structures. To this end, it is preferred that the at least one energy director is located on at least one of said mating structures. Ideally, the at least one energy director is located at a position between mating surfaces that are pressed together during welding.

It will be appreciated that molten material generated during welding may flow away from the intended surfaces to be welded, especially when pressure is applied. To ensure that the molten material is directed to a position where it is most effective, it is preferred that the complementary interfaces comprise one or more weld sinks into which molten material can be captured. Ideally, there are a plurality of weld sinks that are positioned on the complementary interfaces. Ideally, the weld sinks are arranged at a boundary of a region of the complementary interfaces to be welded together. Advantageously, this can ensure that the molten material is contained within said region and/or directed to where it is most required. Ideally, the weld sinks are predefined gaps between the mating structures. For example, where the mating structures comprise an annular projection and a complementary annular groove, the weld sinks may be defined by the annular projection having chamfered edges. As a result, the weld sinks are therefore in the form two annular gaps between the chamfered edges of the annular projection and the non-chamfered corners of the annular groove.

Naturally, the first aspect of the invention may also extend to an aerosol container, for example, produced from the preform, the adapter and/or the body. Ideally, the aerosol container is produced by stretch blow-moulding the preform. Similarly, the first aspect of the invention also extends to an aerosol assembly comprising the aerosol container provided with an aerosol valve assembly. In particular, the aerosol valve assembly may comprise a valve cap which is fitted to the opening of the aerosol container, ideally via crimping the valve cap thereto. Additionally, the aerosol assembly may comprise a pressurised product to be dispensed via the aerosol valve assembly.

According to a second aspect of the present invention, there is provided an aerosol container produced from a preform constructed from a plastics material, the container comprising:
an adapter defining an opening of the container, the opening being arranged to receive and be sealed by an aerosol valve cap; and
a body defining an internal volume of the aerosol container;
wherein
the internal volume defined by the body is substantially derived from an expansion region of the preform expanded by blow-moulding the preform; and
the adapter of the aerosol container is substantially derived from a region of the preform unexpanded by said blow-moulding.

Ideally, said internal volume is the majority of the total internal capacity of the aerosol container. Ideally, said internal volume is at least 70% of the total internal capacity of the aerosol container. Ideally, said internal volume is at least 90% of the total internal capacity of the aerosol container.

The aerosol container associated with the first or second aspect of the invention ideally comprises a body substantially derived from a blow-moulded expansion region of the preform. Ideally, the body defines a free-standing base of the container. Ideally, the free-standing base comprises a rim on which the container is supported. Advantageously, this allows the container to stably stand on a substantially level planar surface. Ideally, said rim defines a continuous contact region on which the container can be stably supported.

As the base is effectively part of the blow-moulded body, it will have relatively thin walls. Accordingly, the base design needs to account for the significant internal pressure within the aerosol container. In particular, it is desirable for the base to resist the effects of such internal pressure, in that the base should not deform under pressure in a way that disrupts the integrity or stability of the base.

Specifically, an underside of the base, radially within the rim, ideally defines a first depression. Ideally, the depression follows the contour of a first oblate spheroid centred on a longitudinal axis of the container. Ideally, the first depression transitions into the rim, for example, at an axially-lower, radially-outer position. Moreover, it is preferred that the underside of the base further defines a strengthening formation that interrupts the contour of the first depression.

Ideally, the strengthening formation, at least in part, follows the contour of a second oblate spheroid centred on the longitudinal axis of the container, the second oblate spheroid being smaller than the first oblate spheroid that defines the first depression. Ideally, the first depression transitions into the strengthening formation at an axially-upper, radially-inner position of the base. Ideally, the first depression transitions into the strengthening formation via an annular or frustoconical transition portion. Ideally, the strengthening formation comprises a second depression.

Advantageously, this arrangement of spheroidal surfaces and annular or frustoconical transition portions define a base that is particularly effective at resisting internal pressure, especially the range of pressures to which aerosol containers may typically be subjected. Aerosol containers need to be more durable and must be able to withstand pressures far greater than containers in other technical fields such as those intended for food and beverage. For an example container, at room temperature, having an internal capacity of around 250-350 ml, the standard operating pressure is around 4-6 bar, with the maximum pressure being over 10 bar, ideally between 15 and 22 bar.

It should be noted that the overall size of the aerosol container needs to be large enough to hold a practical quantity of product and propellant. For example, the total capacity of the container may be within the range 30 ml to 1 litre, more preferably the range 100 ml-600 ml, even more preferably within the range 200-400 ml.

In addition to this, it is desirable for the aerosol container to be easily hand-held. With this in mind the major circumference of the container (in particular, defined by the body) may be in the range 80 mm to 350 mm. Preferably, the range of the major circumference of the container is 100-300 mm, more preferably within the range 125-200 mm. Typically, the aerosol container (in particular, the body) will be substantially cylindrical.

As a result of this, the longitudinal length of the container can be roughly determined by dividing the capacity by the cross-sectional area, the cross-sectional area being determined from the circumference. This association assumes a container shape having a substantially constant cross-sectional area over almost all of its longitudinal length. However, in practice, some leeway is given to account for the reduced capacity typically at the upper and lower ends of the container, where the container narrows and/or has concave formations (e.g. due to the design of the base). Nonetheless, the longitudinal length of the aerosol container is general within the range 70 mm to 200 mm for capacities in the range 200 ml to 400 ml, assuming the container is of a broadly cylindrical shape.

Capacities of the aerosol container have so far been expressed as a total internal capacity, or “brim-full” volume. It will however be appreciated that the total capacity of the aerosol container is shared between the product and the propellant. For example, when full, the product typically occupies 60-95% of the total capacity of the aerosol container, ideally 70-80%. The rest of the volume is occupied by the propellant. Naturally, the proportion changes as the product is dispensed.

According to a third aspect of the present invention there is provided an aerosol assembly comprising an aerosol container according to the second aspect, or produced from a preform according to the first aspect, and an aerosol valve assembly. Ideally, the aerosol valve assembly comprises an aerosol valve cap. Naturally, the aerosol assembly may also comprise a product to be dispensed and a propellant. The propellant may be a liquefied propellant.

According to a fourth aspect of the present invention there is provided a manufacturing method. Ideally the manufacturing method is for producing a preform, aerosol container and/or aerosol assembly according to first to third aspects of the present invention. Ideally, the manufacturing method comprises at least one of the steps of:
(a) providing an adapter and a body each having complementary interfaces;
(b) securing the complementary interfaces of the adapter and body to one another to produce a preform suitable for blow-moulding into an aerosol container;
(c) producing an aerosol container by:
   (i) heating an expansion region of the body, the expansion region being ideally spaced from the interface of the body; and
   (ii) expanding the expansion region of the body via stretch blow-moulding to form an internal volume of the aerosol container; and
(d) producing an aerosol assembly by:
   (i) crimping an aerosol valve cap to an opening of container to close the aerosol container, the aerosol valve cap supporting an aerosol valve; and
   (ii) filling the container with a pressurised product and/or propellant via the valve.

Ideally, step (a) comprises injection moulding the adapter and body. Ideally, step (b) comprises welding the complementary interfaces of the adapter and the body together, ideally via ultrasonic welding. Ideally, step (b) comprises pressing the complementary interfaces of the adapter and the body together.

Different features and advantages of the different aspects of the invention may be combined or substituted where context allow.

Further features and advantages of the present invention will become apparent when considering the specific embodiments of the present invention which are described below, by way of example, with reference to the following drawings.

### BRIEF DESCRIPTION OF THE DRAWINGS

FIG. 1 is a sectional view of an aerosol assembly comprising an aerosol container according to an embodiment of the present invention;

FIG. 2 is a perspective overhead view of the assembly of FIG. 1;

FIG. 3 is an underneath perspective view of the assembly of FIG. 1;

FIG. 4 is a sectional view of the aerosol container of FIG. 1, the container being produced from a preform, the preform comprising an injection-moulded adapter welded to a body, the body being biaxially stretch blow-moulded;

FIG. 4a is a schematic enlarged partial view of region—a—of the container of FIG. 4;

FIG. 5 is a perspective overhead view of the container of FIG. 4;

FIG. 6 is an underneath perspective view of the container of FIG. 4;

FIG. 7 is a sectional view of the preform use to produce the aerosol container of FIG. 4.

FIG. 8 is a side view of the preform of FIG. 7;

FIG. 9 is a perspective side view of the preform of FIG. 7;

FIG. 10 is an exploded sectional view of the preform of FIG. 7;

FIG. 10a is a schematic enlarged partial view of region—b—of the preform of FIG. 10;

FIG. 11 is an exploded side view of the preform of FIG. 7; and

FIGS. 12 and 13 are exploded perspective views of the preform of FIG. 7;

### SPECIFIC DESCRIPTION

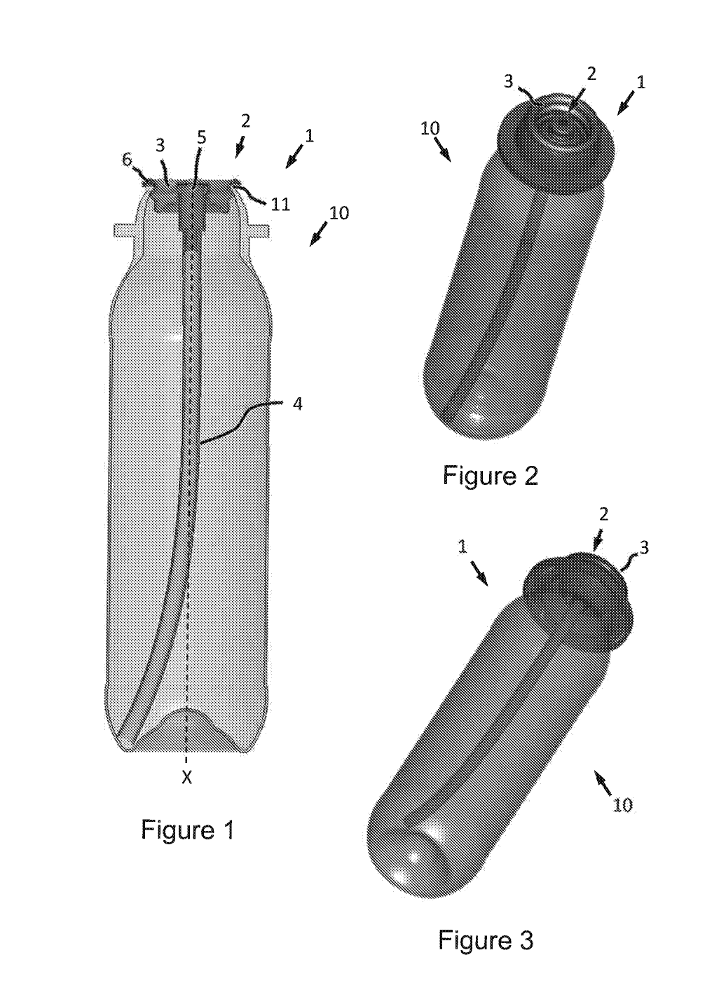

FIG. 1 is a sectional view of an aerosol assembly 1 comprising an aerosol container 10 according to an embodiment of the present invention. The sectional view of FIG. 1 us taken substantially along a plane parallel to a longitudinal axis X of the container 10. FIGS. 2 and 3 are perspective views of said aerosol assembly 1.

The aerosol assembly 1 further comprises a conventional aerosol valve assembly 2 which includes an aerosol valve cap 3, a dip tube 4, and an aerosol valve 5. As the aerosol valve assembly 2 is conventional, certain features of it such as a valve stem, spring and inner gasket are omitted in the interests of brevity. The aerosol assembly 1 also comprises a resilient sealing member 6 that is crushed between the valve cap 3 and the container 10 during crimp-fitting of the valve cap 3 to ensure that an opening 11 of the container 10 is hermetically sealed.

The container 10 is substantially rotationally symmetrical about the longitudinal axis X. Similarly, the aerosol valve cap 3 is also rotationally symmetrical thereby simplifying fitting of the valve cap 3 to the container 10.

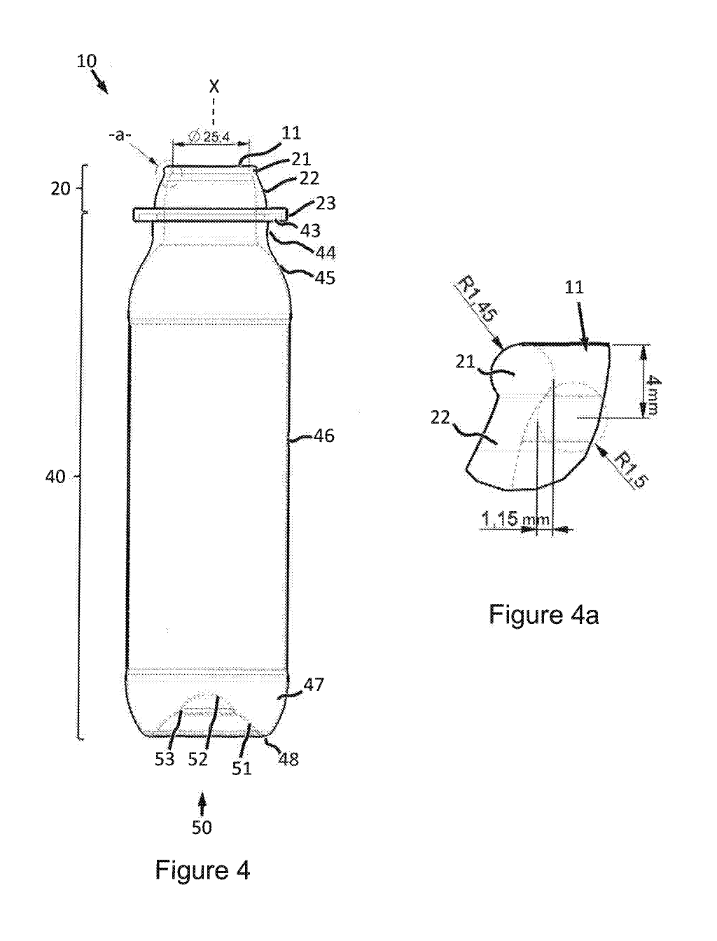

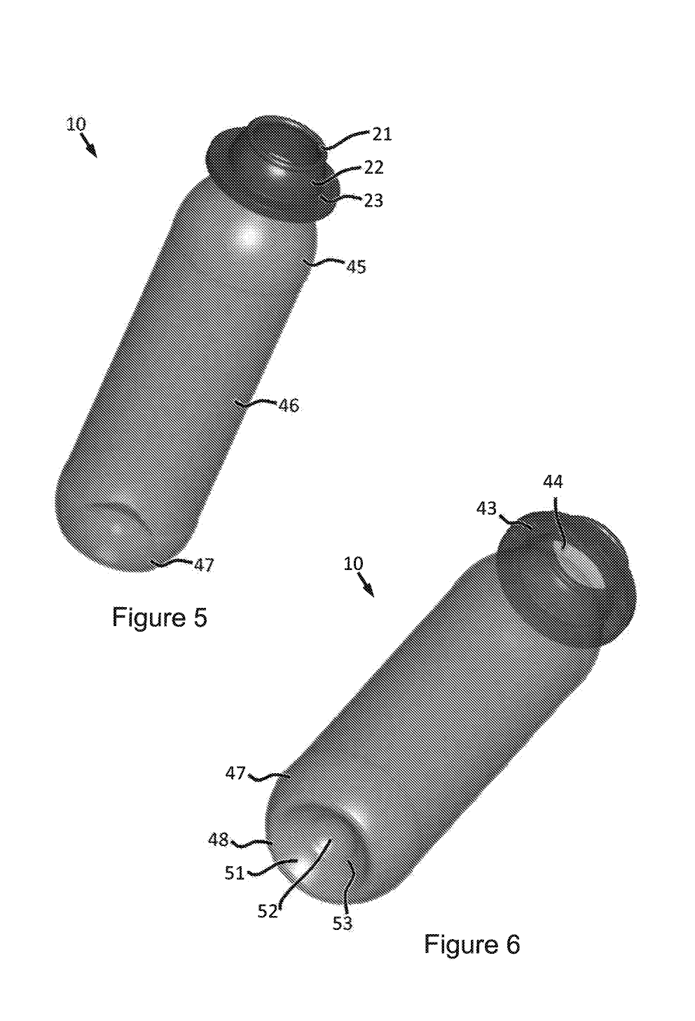

FIG. 4 is a corresponding sectional view of the aerosol container 10 of FIG. 1 shown in isolation—i.e. without the aerosol valve assembly 2. FIGS. 5 and 6 are perspective views of said aerosol container 10 of FIG. 4.

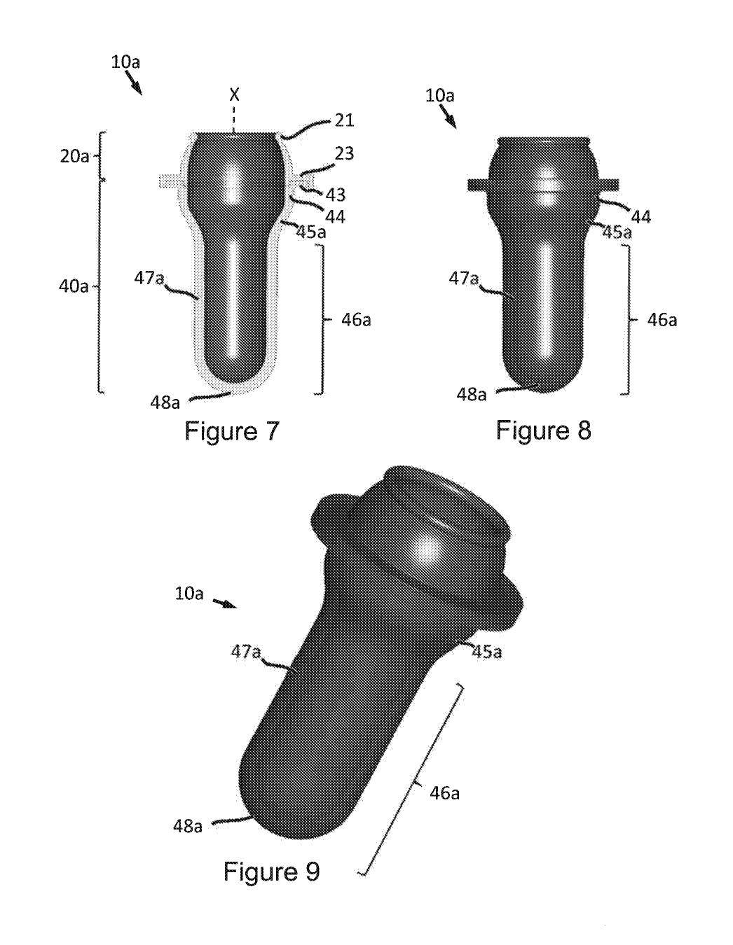

The container 10 is effectively made of two parts; an adapter 20 and a body 40. As will be described in greater detail below, the container 10 is produced from a preform 10a, a sectional view of which is shown in FIG. 7. The preform 10a has an adapter 20a and a body 40a from which the container adapter 20 and body 40 are derived. These are secured and sealed to one another before the preform 10a is used to produce the container 10. Individually, the adapter 20a and body 40a of the preform 10a are each formed from an integral piece of PET that is produced via injection-moulding.

Referring back to FIG. 4, the adapter 20 defines the opening 11 of the container 10. Specifically, the adapter 20 comprises a lip 21 broadly shaped like a torus and centred on the longitudinal axis X of the container 10. Moreover, at an axially-upper end of the adapter 20, the lip 21 forms a crest of a dome-shaped mouth 22 of the adapter 20.

These structures can be seen more clearly in FIG. 4a which is a schematic enlarged partial view of region—a—of the container 10 of FIG. 4; i.e. an enlarged view of the lip 21. Here it can be seen that the lip 21 and axially-upper end of the mouth 22 extend radially-inwards to define an undercut. This is so that when the aerosol valve cap 3 is crimp-fitted around the lip 21 a lower portion of the valve cap 3 enlarged by the crimping will not be able to fit through the opening; the undercut effectively restrains the valve cap 3 from sliding out from the opening 11 under action of an internal pressure within the aerosol assembly 1.

The dimensions shown in FIGS. 4 and 4a are replicated here for ease of reference and clarity:

| Description | Value |
|---|---|
| Diameter of the opening defined by the lip (Ø25,4) | 25.4 mm |
| Radius of curvature of the torus-shaped lip (R1,45) | 1.45 mm |
| Radius of curvature of the lower enlarged portion of the | 1.5 mm |
| valve cap that is restrained by the lip (R1,5) | |
| Difference in radial width between the narrowest part of the | 1.15 mm |
| opening as defined by the lip, and the relatively wider | |
| widest part of the lower enlarged portion of the valve | |
| cap that is restrained by the lip | |
| Axial height from the widest part of the lower enlarged | 4 mm |
| portion of the valve cap to brim of the container | |
| (i.e. the top of the lip) | |

Referring back to FIGS. 4, 5 and 6, the dome-shaped mouth 22 is interrupted at an axially-lower end of the adapter 20 by a circumferential flange 23. The circumferential flange 23 generally protrudes from an axially-lower end of the mouth 22 in a radially-outward direction away from the exterior surface of the mouth 22 extending substantially parallel to a plane orthogonal to the longitudinal axis X. The circumferential flange 23 of the adapter 20 is secured along its entire circumference to a complementary flange in the form of a collar 43 of the body 40, thereby sealing and securing the adapter 20 to the body 40.

The collar 43 is located at an axially-upper end of the body 40. Moreover, it generally protrudes from an axially-upper end of a generally cylindrical neck 44 of the body in a radially-outward direction away from the exterior surface of the neck 44. Similar to the circumferential flange 23, the collar 43 also extends substantially parallel to a plane orthogonal to the longitudinal axis X.

At an axially-lower end of the neck 44, the neck 44 surmounts and smoothly transitions into a dome-shaped shoulder 45 which, in turn, connects via a first transition zone to a substantially cylindrical side-wall 46 which substantially encircles and is centred on the longitudinal axis X. The circumference of the dome-shaped shoulder 45 at the first transition zone is slightly greater than that of the cylindrical side-wall 46, and so the first transition zone is broadly frustum-shaped tapering radially-inwards from the axially-lower end of the shoulder 45 to the axially-upper end of the side-wall 46. The major circumference of the container is approximately 150 mm.

At the axially-lower end of the side-wall 46, it connects via a second transition zone to a trunk region 47 of the body 40. The trunk region 47 assumes an inverted and truncated dome shape, generally tapering radially-inwards towards an axially-lowermost end of the body 40. The circumference of the trunk region 47 at the second transition zone is slightly greater than that of the cylindrical side-wall 46, and so the second transition zone is also broadly frustum-shaped tapering radially-outwards from the axially-lower end of the side-wall 46 to the axially-upper end of the trunk region 47. At its axially-lowermost end, the body 40 curves in on itself to define a rim 48 which provides continuous contact region on which the container 10 is stably supported. The rim 48 forms part of a pressure-resistant freestanding base 50 of the body 40 and so the container 10 in general.

Radially-inward of the rim 48, when viewed from an exterior of the container 10, the underside of the base 50 is generally concave. Specifically, the underside of the base 50 defines a first depression 51 that follows the contour of a first oblate spheroid centred on a longitudinal axis X of the container 10. The first depression 51 and rim merge together at an axially-lower, radially-outer position of the base 50. The underside of the base 50 also defines a strengthening formation in the form of a second depression 52. The second depression also follows the contour of a second oblate spheroid centred on the longitudinal axis X of the container 10. However, the second oblate spheroid is smaller than the first oblate spheroid that defines the first depression 51, and extends to an axially-higher position than the first oblate spheroid. Thus, the second depression 52 interrupts the contour of the first depression 51 at an axially-upper, radially-inner position of the first depression 51, the transition between the first and second depressions being defined by frustoconical transition portion 53.

The features of the adapter 20, such as the lip 21, mouth 22 and flange 23 are integral with one another in that they are constructed from an integral piece of PET. Similarly, the feature of the body 40, such as the collar 43, neck 44, shoulder 45, side-wall 46, trunk region 47 and base 50 are also integral with one another.

As mentioned, the container 10 is produced from the preform 10a. Moreover, and referring back to FIG. 7, the container 10 is blow-moulded from the preform 10a. Specifically, comparing FIG. 7 with FIG. 4, it is an expansion region of the body 40a of the preform 10a that is biaxially stretch blow-moulded to form expanded parts of the body 40 of the container 10. The expanded parts of the body 40 can be readily discerned from FIG. 4 as their walls are significantly thinner than those of the unexpanded parts of the body 40. For the avoidance of doubt, the expanded parts of the body 40 include the base 50, trunk region 47, side-wall 46 and most of the shoulder 45. The unexpanded parts of the body 40 include the axially upper-end of the shoulder 45, the neck 44 and the collar 43.

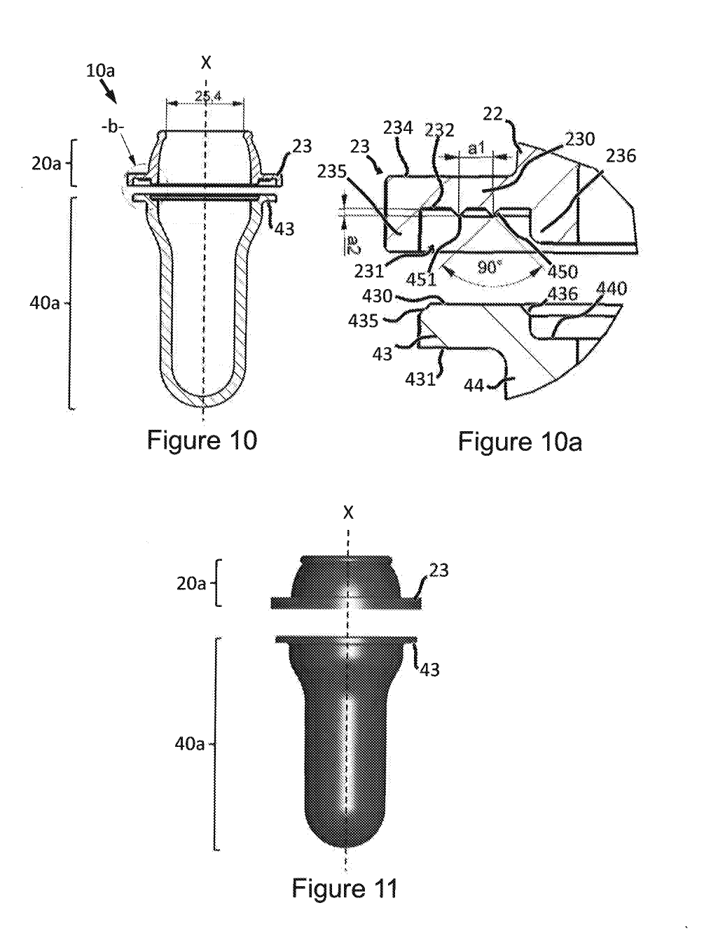

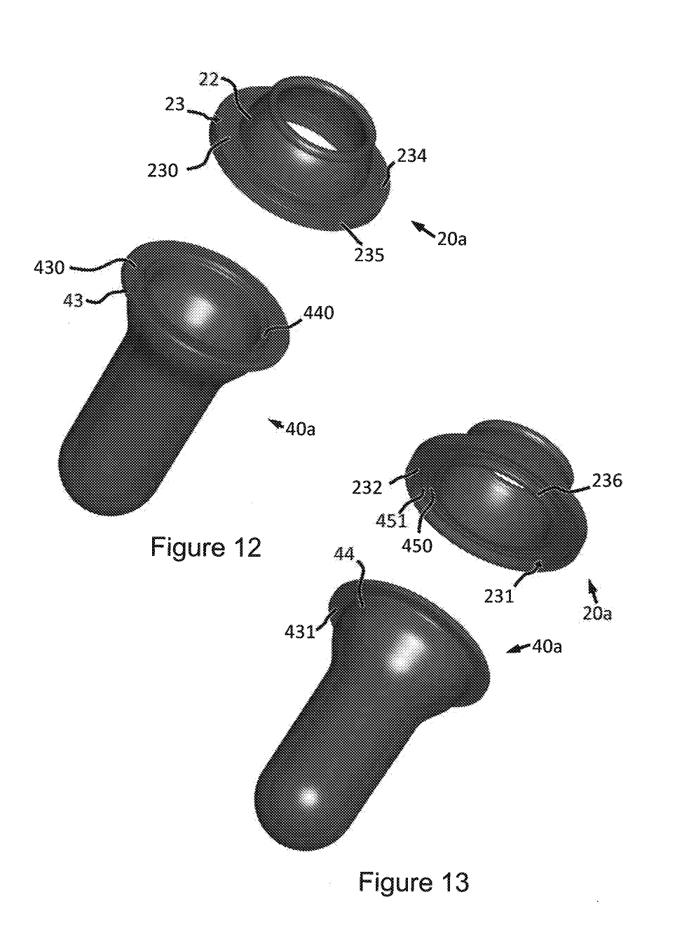

In contrast, the adapter 20a of the preform 10a is not modified by the conversion from the preform 10a to container 10; i.e. it is not deformed by the act of blow-moulding. Accordingly, and referring to FIGS. 7 to 9, the adapter 20a of the preform 10a has the same principle features of the adapter 20 of the container 10. Similarly, the unexpanded parts of the body 40 of the container 10—namely, the collar 43 and the neck 44 substantially match those of the preform 10a. Thus, these features in common are denoted by like reference numerals.

Unlike the body 20 of the container 10, the body 20a of the preform 10a comprises a generally frustoconical throat portion 45a and a generally bullet-shaped tail portion 46a. These together define the main expansion region of the body 20a of the preform 10a.

The tail portion 46a comprises a shaft 47a that joins on to the throat portion 45a at its axially-upper end. The shaft 47a is terminated at the axially-lower end of the preform 10a by a spheroidal tip 48a which defines a closed end of the preform 10a. Whilst the shaft is broadly cylindrical in shape, it does slightly tapered radially-inwards in the direction of the tip 48a. This, in combination with a substantially constant wall thickness provides the body 40a with a draft that allows it to be easily withdrawn from an injection mould. Moreover, the body 40a has an internal blind-bore that widens in the direction of the aperture at the axially-upper end of the body 40a, as delimited by the collar 43.

Similarly, it should be noted that the internal bore of the adapter 20a widens in one direction—i.e. from the lip 21 at the axially-upper end of the adapter 20a to the axially-lower end of the adapter 20a adjacent the flange 23. However, whilst the internal bore of the body 40a is a blind-bore that is closed at the tip 48a, the internal bore of the adapter 20a is a through-bore.

Accordingly, the preform 10a formed by the joined adapter 20a and body 40a has an internal bore that is narrower at the ends of the preform 10a (i.e. the tip 48a and lip 21) than in the middle (i.e. at the flange 23 and collar 43). Such a preform cannot be produced in one piece via conventional injection moulding techniques.

FIG. 10 is an exploded sectional view of the preform of FIG. 7, showing the adapter 20a and the body 40a as individual parts. As will now be described in greater detail, the adapter 20a and body 40a are secured and sealed together to create the preform 10a. This is achieved via the complementary interfaces of the adapter 20a and the body 40a, which are presently embodied by the circumferential flange 23 of the adapter 20a and the collar 43 of the body 40a.

FIG. 10a is a schematic enlarged partial view of region—b—of the preform of FIG. 10 which shows the structure of the circumferential flange 23 and the collar 43 in more detail. In general, the circumferential flange 23 of the adapter 20a defines an annular groove 231 within which the collar 43 of the body 40a can be received when the adapter 20a and body 40a are joined together. Thus, the flange 23 and collar 43 effectively define mating structures that mate the adapter 20a and body 40a together, with the collar 43 locating within the circumferential flange 23.

In more detail, the collar 43 extends in a radially-outward direction away from an exterior surface of the underlying neck 44 with which it is integrally-formed. Furthermore, it is offset radially-outwards from the underlying neck 44 of the body 40a so that a radially-inner part of the axially-upper end of the neck 44 defines an axially-upwardly facing seat 440. The collar 43 merges to the corresponding radially-outer part of the axially-upper end of the neck 44. The collar 43 also extends in axially-upward direction. The collar 43 is broadly of the shape of a rectangular toroid, but with its axially-upper edges 435, 436 being chamfered, and its axially-lower, radially-inner edge merging smoothly with the neck 44. The collar 43 thereby defines an axially-upwardly-facing joining surface 430, and an axially-downwardly-facing clamping surface 431.

In complement, the circumferential flange 23 of the adapter 20a comprises an annular portion 230 which extends in a radially-outward direction away from an exterior surface of the mouth 22 with which the flange 23 is integrally-formed. The annular portion 230 is subtended at its radially-outer end by a first circumferential skirt 235 which extends axially downwards, bounding one side of the annular groove 231. The annular portion 230 is subtended at its radially-inner end by a second circumferential skirt 236 which also extends axially downwards, and defines the other side of the annular groove 231. The annular portion 230 also comprises an axially-downwardly-facing joining surface 232, and an axially-upwardly-facing clamping surface 234.

The annular groove 231 defined by the circumferential flange 23 has a radial width, and an axial height that accommodates the collar 43 such that when the adapter 20a and body 40a are sealed to one another, the respective joining surfaces 232, 430 contact one another and the skirts 235, 236 locate either side of the collar 43, with the second circumferential skirt 236 substantially joining the seat 440 of the neck 44. The radial width and positioning of the mated seat 440 and second circumferential skirt 236 match one another. Accordingly, the diameter of the internal bore across the interface of the adapter 20a and the body 40a is substantially constant.

The chamfered edges 435, 436 of the collar 43 mean that annular gaps each of approximately triangular section are defined between the chamfered edges 435, 436 of the collar 43 and the non-chamfered corners of the annular groove 231.

Integrally-formed with, and projecting from the joining surface 232 of the annular portion 230 are a concentric pair of energy directors 450, 451 each of which are broadly of the shape of a triangular toroid. The radial distance a1 between each energy director 450, 451 is approximately 1.8 mm, and the axial height a2 of each energy director 450, 451 is approximately 0.4 mm. In alternatives, the radial distance a1 is typically within the range 0.5 mm to 3 mm, and the axial height a2 is typically within the range 0.2 mm to 0.7 mm. In the sectional view shown in FIG. 10a, two axially-downwardly-facing faces of each energy director 450, 451 are at right-angles to one another such that each energy director terminates at a sharp circular apex.

As mentioned previously, the adapter 20a and body 40a of the preform 10a are each made from an integral piece of PET produced via injection-moulding. In particular, they are produced as individual parts which are then welded together to create the preform 10a as will be described with reference to FIG. 11, which is an exploded side view of the preform of FIG. 7.

The adapter 20a and the body 40a are positioned so that their respective central longitudinal axes are aligned along the common longitudinal axis X. The adapter 20a and the body 40a are then moved towards one another along said axis X until their complementary interfaces partially mate, with the apices of the energy directors 450, 451 being pressed against the axially-upwardly-facing joining surface 430 of the collar 43. A clamping force is applied via the clamping surfaces 234, 431 of the flange 23 and collar 43 and a welding energy is applied locally to the region of the adapter 20a and body 40a adjacent to the joining surfaces 430, 232. Specifically, a sonotrode is applied to the clamping surface 234 of the flange 23 so that high-frequency ultrasonic vibrations are passed through to the energy directors 450, 451, the apices of which vibrate relative to the adjoining joining surface 430 of the collar 43. The sharp contact edge of the apices of the energy directors 450, 451 concentrates the welding energy so that the energy directors 450, 451 melt before any other underlying material of the flange 23 and collar 43. The toroidal shape of the concentric energy directors 450, 451 results in two molten loops being formed. These molten loops coalesce together as the energy directors 450, 451 continue to melt and the adapter 20a and body 40a are pressed closer together. Furthermore, as the gap between the facing joining surfaces 232, 430 narrows, the molten material is squeezed to the radial extremities of the joining surfaces 232, 430. However, flow of molten material is substantially confined to the joining surfaces 232, 430 by the annular gaps between the chamfered edges 435, 436 of the collar 43 and the non-chamfered corners of the annular groove 231. Thus, these annular gaps effectively define weld sinks that form the boundaries of the region of the adapter 20a and body 40a that are to be welded together. A weld zone can thereby be accurately established.

When substantially all the material forming the energy directors 450, 451 has melted and the complementary interfaces are in a fully mated position, the welding energy is removed and the weld allowed to cool. The preform 10a is thereby formed, and ready for stretch blow-moulding to form the aerosol container 10.

Specifically, biaxial stretch blow-moulding of the preform 10a is carried out by heating the preform 10a at the expansion region of the tail portion 46a, applying a push-rod via the internal bore to stretch the tail portion 46a in the axial direction, and then blowing air into the preform 10a to expand it in a radially-outward direction to take the shape of a mould. The resulting biaxially-stretched container 10 is highly resistant to internal pressure.

The axial spacing of the interface and, moreover, the opening from the expansion region ensures that the opening is not deformed by the stretch blow-moulding operation. Therefore, the reliability with which the aerosol valve cap is subsequently fitted to the opening to produce an aerosol assembly is increased.

Further features and advantages will be apparent to a person skilled in the art considering the drawings. Furthermore, modifications and variants to the present embodiment will be apparent to a person skilled in the art.

1. A preform arranged to be blow-moulded into an aerosol container, the preform comprising:
an adapter and a body, each having complementary interfaces via which the adapter and body are secured to one another;
the adapter defining an opening of the preform, the opening being arranged to receive and be sealed by an aerosol valve cap; and
the body comprising an expansion region arranged to be expanded via blow-moulding to form an internal volume of the aerosol container.

2. The preform of claim 1, wherein the adapter and the body are each formed from an integral piece of plastics material, ideally polyethylene terephthalate (PET), wherein the adapter and/or the body are injection-moulded.

3. (canceled)

4. The preform of claim 1, wherein the expansion region of the body is spaced from the interface of the body.

5. The preform of claim 1, wherein the opening is spaced from the interface of the adapter.

6. The preform of claim 1, wherein the complementary interfaces of the body and the adapter comprise joining surfaces that are joined and sealed together along a continuous loop, wherein the complementary interfaces are sealed together via welding, ideally ultrasonic welding.

7. (canceled)

8. The preform of claim 1, wherein the adapter and the body each comprise a flange that extends in an outward direction away from an exterior surface of the respective adapter and body, each flange supporting the interface of the respective adapter and body, wherein the interfaces are supported on respective facing surfaces of the flanges and respective reverse surfaces of the flanges are arranged to transmit a clamping force so as to drive the facing surfaces together.

9. (canceled)

10. The preform of claim 1, wherein the adapter comprises an internal bore that narrows towards the opening, wherein the adapter comprises a radially-inwardly projecting lip around which an aerosol valve cap can be crimp-fitted.

11. (canceled)

12. An adapter and/or body for use in constructing the preform of claim 1.

13. The adapter and/or body of claim 12, comprising at its respective interface at least one energy director shaped to melt upon application of welding energy to facilitate welding of one of the adapter and body to the other.

14. The adapter and/or body of claim 13, formed from an integral piece of plastics material, said energy director being also formed from said integral piece of plastics material and shaped to be more predisposed towards melting upon application of welding energy than an underlying portion of said material.

15. The adapter and/or body of claim 13, wherein the at least one energy director is positioned and arranged so that, when melted upon application of welding energy, it forms a continuous molten loop for joining and sealing together the complementary interfaces of the adapter and/or body.

16. An aerosol container produced from the preform, adapter and/or body of claim 1.

17. An aerosol container produced from a preform constructed from a plastics material, the container comprising:
an adapter defining an opening of the container, the opening being arranged to receive and be sealed by an aerosol valve cap; and
a body defining an internal volume of the aerosol container;
wherein
the internal volume defined by the body is substantially derived from an expansion region of the preform expanded by blow-moulding the preform; and
the adapter of the aerosol container is substantially derived from a region of the preform unexpanded by said blow-moulding.

18. The aerosol container of claim 16, further comprising a body substantially derived from a blow-moulded expansion region of the preform, wherein the body defines a free-standing base of the container, wherein the free-standing base comprises a rim on which the container is supported.

19. (canceled)

20. The aerosol container of claim 18, wherein an underside of the base defines a first depression, wherein the underside of the base further defines a strengthening formation that interrupts the contour of the first depression, and wherein the strengthening formation comprises a second depression.

21. (canceled)

22. (canceled)

23. The aerosol container of claim 20, wherein
the first depression follows the contour of a first oblate spheroid centred on a longitudinal axis of the container, the first depression transitioning into the rim at an axially-lowermost, radially-outer position; and
the strengthening formation follows the contour of a second oblate spheroid centred on the longitudinal axis of the container, the second oblate spheroid being smaller than the first oblate spheroid that defines the first depression, the first depression transitioning into the strengthening formation at an axially-upper, radially-inner position of the base.

24. An aerosol assembly, comprising the aerosol container of claim 16 and an aerosol valve.

25. A method of manufacturing comprising:
(a) providing an adapter and a body each having complementary interfaces; and
(b) securing the complementary interfaces of the adapter and body to one another to produce a preform suitable for blow-moulding into an aerosol container.

26. The method of claim 25, wherein step (a) comprises injection moulding the adapter and body, wherein step (b) comprises welding the complementary interfaces of the adapter and the body together, ideally via ultrasonic welding, and wherein step (b) comprises pressing the complementary interfaces of the adapter and the body together.

27. (canceled)

28. (canceled)

29. The method of claim 25, further comprising:
(c) producing an aerosol container by:
(i) heating an expansion region of the body, the expansion region being spaced from the interface of the body; and
(ii) expanding the expansion region of the body via stretch blow-moulding to form an internal volume of an aerosol container.
